(19) United States
(12) Patent Application Publication
(10) Pub. No.: US 2018/0212219 A1
(43) Pub. Date: Jul. 26, 2018

(54) POROUS HEAT-RESISTANT LAYER COMPOSITION, SEPARATION MEMBRANE COMPRISING POROUS HEAT-RESISTANT LAYER COMPOSITION, AND LITHIUM SECONDARY BATTERY USING SAME

(71) Applicant: SAMSUNG SDI CO., LTD., Yongin-si, Gyeonggi-do (KR)

(72) Inventors: Yang Seob KIM, Suwon-si (KR); Se Yeong KANG, Suwon-si (KR); Dae Gyu LEE, Suwon-si (KR); Im Hyuck BAE, Suwon-si (KR)

(21) Appl. No.: 15/747,710

(22) PCT Filed: Apr. 22, 2016
(86) PCT No.: PCT/KR2016/004259

§ 371 Date: Jan. 25, 2018

(30) Foreign Application Priority Data
Aug. 28, 2015 (KR) 10-2015-0121868

(51) Int. Cl. H01M 2/16; H01M 10/0525

(52) U.S. Cl. CPC H01M 2/166; H01M 2/1686; H01M 2220/30; H01M 10/0525; H01M 2/162

(57) ABSTRACT

The present invention relates to a porous heat-resistant layer composition for a separation membrane for a battery, comprising: a crosslinkable binder selected from monomeric oligomers, polymers or mixtures thereof having at least one functional group; an inorganic particle surface-treated with a functional group capable of reacting with the crosslinkable binder; a polymerization initiator; and a solvent.

Also, the present invention relates to a separation membrane and a lithium secondary battery comprising the same, the separation membrane comprising a porous substrate and a porous heat-resistant layer formed on one or both surfaces of the substrate, wherein the porous heat-resistant layer comprises a crosslinked structure binder and an inorganic particle, and the inorganic particle is surface-treated with a functional group and reacted with the crosslinked structure binder.

### TECHNICAL FIELD

The present invention relates to a porous heat-resistant layer composition having high heat-resistance, a separation membrane including the porous heat-resistant layer composition, and a lithium secondary battery using the same.

### BACKGROUND ART

In general, as a portable electronic device such as a video camera, a cell phone, and a portable computer is lightened and conducts high performance, research on a secondary battery as a power source for the portable electronic device is actively being made. This secondary battery may include, for example, a nickel-cadmium battery, a nickel-hydrogen battery, a nickel-zinc battery, a lithium secondary battery, and the like. Among these batteries, the lithium secondary battery may be down-sized and enlarged and also has an advantage of a high voltage and high energy density per unit weight and thus is used in many fields.

A separation membrane (separator) for an electrochemical battery refers to an interlayer separating positive and negative electrodes in the battery and thus maintaining ion conductivity and charging and discharging the battery.

On the other hand, when a battery is externally short-circuited, a high current flows therein, causes a heat, increases a battery temperature, and starts a thermal runaway, and accordingly, the battery may have a problem of malfunction of a safety valve, explosion, and the like due to evaporation of an electrolyte solution or heating. In order to prevent the problem, a separation membrane including a porous material formed of a thermally fusible resin may be used and thus the separation membrane may be fused at a particular temperature and block an opening, which performs a shut-down function of stopping a battery reaction and suppressing exothermicity

However, since a large-sized secondary battery relatively less radiates heat than a small-sized secondary battery and thus becomes highly exothermic during a short circuit and the like, an internal battery temperature may be increased up to greater than or equal to about 200° C. within a couple of seconds. Herein, a separation membrane formed of the thermally fusible resin does not only block an opening during the fusion but also is even fused itself and just melt down (Korean Registration Patent No. 10-0775310). The melt-down makes electrodes contact and a short circuit current flow therein again and thus keeps an exothermic state and leads to a thermal explosion. Accordingly, a separation membrane having no rupture but maintaining a shape and having a good adherence under an environment where an internal temperature in the large-sized secondary battery is increased up to 200° C. or greater within a couple of seconds needs to be provided.

### DISCLOSURE

### Technical Problem

The present invention provides a separation membrane of which shrinkage and rupture characteristics at a high temperature are not decreased and adherence to a substrate is increased.

### Technical Solution

In an example embodiment of the present invention, a porous heat-resistant layer composition of a separation membrane for a battery includes a crosslinkable binder selected from a monomer, an oligomer, a polymer, or a mixture thereof having at least one functional group; an inorganic particle surface-treated with a functional group capable of reacting with the crosslinkable binder; a polymerization initiator, and a solvent.

In another example embodiment of the present invention, a separation membrane for a battery includes a porous substrate; and a porous heat-resistant layer formed on one or both surfaces of the substrate, wherein the porous heat-resistant layer includes a crosslinked structure binder and an inorganic particle and the inorganic particle is surface-treated with a functional group to react with the crosslinked structure binder.

In another example embodiment of the present invention, provided is a lithium secondary battery including a positive electrode, a negative electrode, the separation membrane disclosed in the present application and disposed between the positive electrode and the negative electrode, and an electrolyte.

### Advantageous Effects

According to an example embodiment of the present invention, a separation membrane has excellent heat-resistance shrinkage and rupture characteristics as well as high heat resistance and and may be made into a thin film due to high coating density.

### DESCRIPTION OF THE DRAWING

FIG. 1 is an exploded perspective view showing a lithium secondary battery according to an example embodiment of the present invention.

### MODE FOR INVENTION

Hereinafter, the present invention is described in detail. The inventions that are not described in the present specification may be fully recognized and by conveyed by those skilled in the art in a technical or similar field of the present invention and thus are omitted herein.

An example embodiment of the present invention relates to a separation membrane for a battery including a porous substrate; and a porous heat-resistant layer formed on one or both surfaces of the substrate, wherein the porous heat-resistant layer includes a crosslinked structure binder and an inorganic particle and the inorganic particle that is surface-treated with a functional group and reacts with the crosslinked structure binder.

The porous substrate may have a plurality of pores and may generally be a porous substrate used in an electrochemical device. Non-limiting examples may be a polymer film formed of a polymer or a mixture of two or more selected from the group consisting of polyethylene, polypropylene, polyethyleneterephthalate, polybutyleneterephthalate, polyester, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, and polyethylenenaphthalene. For example, the porous substrate may be a polyolefin-based substrate, and the polyolefin-based substrate may improve has safety of a battery due to its improved shut-down function. The polyolefin-based substrate may be, for example, selected from a polyethylene single film, a polypropylene single film, a polyethylene/polypropylene double film, a polypropylene/polyethylene/polypropylene triple film, and a polyethylene/polypropylene/polyethylene triple film. For another example, the polyolefin-based resin may include a non-olefin resin in addition to an olefin resin or a copolymer of olefin and a non-olefin monomer. A thickness of the porous substrate may be 1 μm to 40 μm, specifically 1 μm to 25 μm, and more specifically 1 μm to 15 μm. When the porous substrate has a thickness within the ranges, a separation membrane may have a desirable thickness that is thick to prevent a short-circuit between the positive electrode and the negative electrode of a battery and is also not thick to increase internal resistance.

The porous heat-resistant layer may be formed from the porous heat-resistant layer composition and the porous heat-resistant layer composition may include a crosslinkable binder, a surface-treated inorganic particle, a polymerization initiator, and a solvent.

The crosslinkable binder refers to a material capable of causing a cross-linking reaction and producing a crosslinked structure binder. The crosslinkable binder may be selected from a monomer, an oligomer, a polymer, or a mixture thereof having at least one functional group. The crosslinkable binder may be cured to improve adherence to a substrate due to a physicochemical bond between the binder and the surface-treated inorganic particle and increase coating density as well as form a physicochemical bond among the monomers, the oligomers, or the polymers and thus make the separation membrane into a thin film.

Specifically, the monomer, the oligomer, the polymer, or the mixture thereof having at least one functional group may be a monomer, an oligomer, or a polymer having a functional group selected from the group consisting of an acrylate group, a vinyl group, a hydroxy group, an epoxy group, an oxane group, an oxetane group, an ester group, and an isocyanate group. The functional group may be two or more, more specifically three or more, and even more specifically four or more.

Examples of the monomer, the oligomer, or the polymer having one or more acrylate groups may be one or more acrylate selected from the group consisting of alkyl(meth)acrylate such as methylmethacrylate, methyl acrylate, and the like; bifunctional (meth)acrylate such as ethylene glycol di(meth)acrylate, propylene glycol di(meth)acrylate, polyethylene glycol di(meth)acrylate, polypropylene glycol di(meth)acrylate, di(meth)acrylate of a polyoxyethylene/polyoxypropylene copolymer, butanediol di(meth)acrylate, hexamethylene glycol di(meth)acrylate, and the like; trifunctional (meth)acrylate such as trimethylol propane tri(meth)acrylate, glycerine tri(meth)acrylate, tri(meth)acrylate of an ethylene oxide adduct of glycerine, tri(meth)acrylate of a propylene oxide adduct of glycerine, ethylene oxide of glycerine, tri(meth)acrylate of a propylene oxide adduct, and the like; tetrafunctional or more multi-functional (meth)acrylate such as diglycerinehexa(meth)acrylate and the like; multi-functional urethane acrylate; multi-functional epoxy acrylate; and polyester acrylate.

Examples of the monomer or the oligomer having one or more vinyl group may be vinyl-pyrrolidone, vinyl-caprolactam, vinyl-imidazole, vinyl-methylacetamide, ethyl vinyl ether, propyl vinyl ether, butyl vinyl ether, pentyl vinyl ether, hexyl vinyl ether, heptyl vinyl ether, octyl vinyl ether, nonyl vinyl ether, decyl vinyl ether, cyclohexyl vinyl ether, ethylhexyl vinyl ether, dodecyl vinyl ether, octadecyl vinyl ether, and the like.

Examples of the monomer, the oligomer, or the polymer having one or more hydroxy group may be biphenol, bisphenol A, methanediol, ethanediol, propanediol, butanediol, pentanediol, hexanediol, heptanediol, octanediol, nonanediol, decanediol, and the like.

Examples of the monomer, the oligomer, or the polymer having one or more epoxy group may be diepoxyalkane such as diepoxyethane, diepoxypropane, diepoxybutane, diepoxypentane, diepoxyhexane, diepoxyheptane, diepoxyoctane, diepoxynonane, diepoxydodecane, and the like; glycidyl ethers such as bisphenol A diglycidylether, bisphenol F diglycidylether, bromide bisphenol A diglycidylether, phenol novolac glycidylether, cresol novolac glycidylether, and the like; glycidyl esters such as hexahydrophthalic acid glycidylester, dimeric acid glycidyl ester, and the like; glycidyl amines such as glycidyl isocyanurate, tetraglycidyl diamino phenylmethane, and the like; linear aliphatic epoxides such as epoxylated polybutadiene, and the like; alicyclic epoxides such as 3,4-epoxy-6-methylcyclohexylmethylcarboxylate, 3,4-epoxycyclohexylmethylcarboxylate, and the like.

Examples of the monomer, the oligomer, or the polymer having one or more isocyanate group may be 4,4′-diphenylenemethane diisocyanate, toluene diisocyanate, tolylene diisocyanate, naphthylene diisocyanate, 4,4′-dicyclohexylenemethane diisocyanate, cyclohexylene diisocyanate, 3,3′-dimethylphenylene diisocyanate, diphenylmethane diisocyanate, 3,3′-dimethyl diphenylenemethane diisocyanate, 4,6′-xylylene diisocyanate, 4,4′-dicyclohexylmethane diisocyanate, 3,5,5-trimethylcyclohexylene diisocyanate, 1,6-hexamethylene diisocyanate, 2,2,4-trimethyl-hexamethylene diisocyanate, m-xylene diisocyanate, trimethylxylene diisocyanate, p-phenylene diisocyanate, isophorone diisocyanate, 1,5-naphthalene diisocyanate, trans-1,4-cyclohexyldiisocyanate, and the like. In addition, in addition to the monomers, oligomers, or polymers, the compound including a structure of Chemical Formula 1 as the monomer, the oligomer, the polymer, or the mixture thereof having at least one functional group may be used.

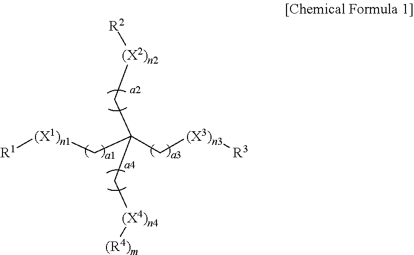

In Chemical Formula 1, X¹ to X³ are independently one selected from functional groups of an oxyethylene group, X⁴ is an oxyethylene group, or a C1 to C10 alkyl group, R¹ to R⁴ are independently one selected from the group consisting of functional groups of a (meth)acrylate group, a hydroxy group, a carboxyl group, an ester group, a cyanate group, an isocyanate group, an amino group, a thiol group, a C1 to C10 alkoxy group, a vinyl group, and a heterocyclic group, a¹ to a⁴ are independently an integer ranging from 1 to 10, n¹ to n³ are independently an integer ranging from 0 to 10, at least one of n¹ to n⁴ is an integer ranging from 1 to 10, provided that when X⁴ is the oxyethylene group, n⁴ is an integer ranging from 1 to 10, and m is 1, and when X⁴ is the C1 to C10 alkyl group, n⁴ is 1, and m is 0.

The ester group may be represented by —COOR, the amino group may be represented by —NR^{a}R^{b}, wherein the R, R^{a}, and R^{b} are independently selected from the group consisting of a C1 to C20 alkyl group, a C2 to C20 alkenyl group, a C2 to C20 alkynyl group, a C3 to C20 cycloalkyl group, a C3 to C20 cycloalkenyl group, a C4 to C20 cycloalkynyl group, and a C6 to C30 aryl group. In addition, the heterocyclic group may be selected from the group consisting of a C2 to C20 heterocycloalkyl group, a C3 to C20 heterocycloalkenyl group, a C3 to C20 heterocycloalkynyl group, and a C6 to C20 heteroaryl group and may include a heteroatom selected from N, O, and S. For example, an epoxy group, an oxetane group, and the like may be exemplified.

Specific examples of the compound of Chemical Formula 1 may be Chemical Formula 2 or 3.

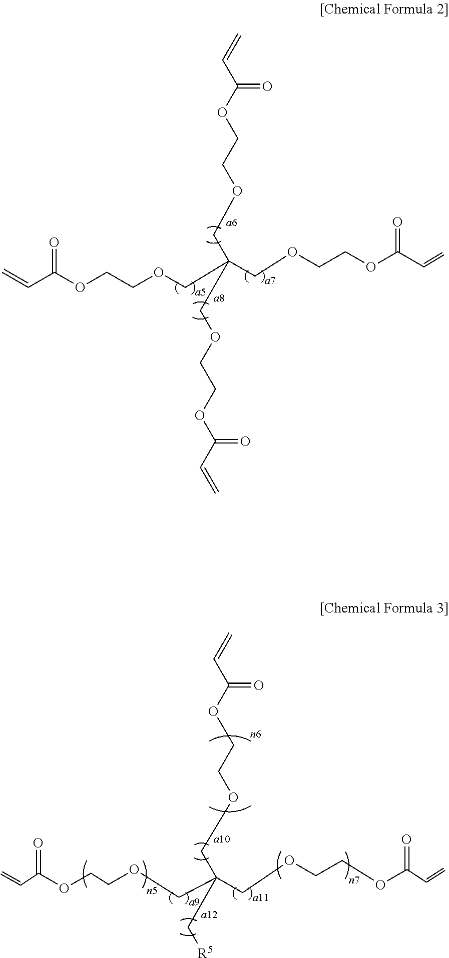

In Chemical Formulae 2 and 3, R⁵ is a C1 to C10 alkyl group, each of n⁵ to n⁷ is an integer of 1 to 5, and each of a⁵ to a¹² is an integer of 1 to 10. More specific examples of Chemical Formula 1 may be ethoxylated pentaerythritol tetraacrylate, ethoxylated trimethylolpropane triacrylate, and the like, but are not limited thereto.

The crosslinkable binder selected from the monomer, the oligomer, the polymer, or the mixture thereof having at least one functional group may be included in an amount of 5 to 50 wt %, specifically 5 to 40 wt %, and more specifically 5 to 25 wt % based on a total solid content of the porous heat-resistant layer composition. Within the ranges, heat-resistance shrinkage and rupture characteristics are improved.

The inorganic particle may be surface-treated so as to react with the crosslinkable binder. Specifically, it may be surface-treated with a functional group capable of reacting with the functional group of the monomer, oligomer, or polymer. A cross-linking reaction between functional groups of the inorganic particle may be caused during a cross-linking reaction of the monomer or the oligomer to improve binding properties between the inorganic particle and the crosslinked structure binder and improve adherence to a substrate and coating density.

For example, the monomer, oligomer, or polymer that is the crosslinkable binder has an acrylate functional group, the inorganic particle may be surface-treated to have an acrylate group. The functional group capable of reacting with the functional group of the monomer, oligomer, or polymer may be selected from the group consisting of a (meth)acrylate group, a vinyl group, a hydroxy group, an epoxy group, an oxane group, an oxetane group, an ester group, and an isocyanate group. Specifically, it may be selected from the group consisting of a (meth)acrylate group, an epoxy group, and more specifically a (meth)acrylate group.

A method of surface-treating the inorganic particle with the functional group is as follows: a cosolvent such as 1-methoxy-2-propanol, ethanol, isopropanol, ethylene glycol, N,N-dimethyl acetamide, and 1-methyl-2-pyrrolidinone is added to a mixture of inorganic dispersion in which the inorganic particle is dispersed or the inorganic particle, and a surface-modifying agent, and they are mixed at room temperature or under temperature-increasing condition or reacted while not mixing. For example, the mixture is reacted at a temperature of about 60° C. to about 120° C. for about 30 minutes to about 50 hours, specifically at a temperature of about 70° C. to about 100° C. for about 1 hour to about 30 hours to obtain a sol including a surface-modified inorganic particle. Then, the surface-modified inorganic particle is precipitated and separated from the sol. When a metal oxide is used as the inorganic particle, the surface-treatment may include adsorption of an acid molecule on a particle surface. According to one example, when silane is used to modify the surface of the inorganic particle, the inorganic particle may be surface-treated through a heat treatment under an acidic or basic condition for an appropriate time. Alternatively, a commercially available inorganic particle surface-treated with a functional group may be used.

The inorganic particle to be surface-treated is not particularly limited, and may be an inorganic particle that is generally in this filed. As examples of the present invention, non-limiting examples of the useable inorganic particle may be Al₂O₃, ZnO₂, SiO₂, B₂O₃, Ga₂O₃, TiO₂, or SnO₂. These may be used alone or in a mixture of two or more. For example, Al₂O₃ (alumina) may be used.

A size of the inorganic particle is not particularly limited, and its average particle diameter may be 1 nm to 100 nm, specifically 10 nm to 80 nm, and more specifically 10 nm to 50 nm. When the inorganic particle having the size within the ranges, dispersibility of the inorganic particle in the porous heat-resistant layer composition and processibility may be prevented from being deteriorated, a thickness of the heat-resistant layer may be appropriately controlled and thus reduction of mechanical properties and increase of electrical resistance may be prevented. In addition, sizes of pores generated in the porous heat-resistant layer are appropriately controlled and thus internal a possibility of short-circuit may be reduced during charge and discharge of a battery.

The inorganic particle may be included in an amount of greater than or equal to 50 wt %, specifically 50 wt % to 95 wt %, specifically 60 wt % to 95 wt %, and more specifically 75 wt % to 95 wt % based on a total solid content of the porous heat-resistant layer. When the inorganic particle is included within the ranges, heat dissipation properties of the inorganic particle may be sufficiently realized, and thermal shrinkage of the separation membrane may be effectively suppressed when the separation membrane is coated using the same.

In preparing of the composition for forming the porous heat-resistant layer, the surface-treated inorganic particle may be used in a form of inorganic dispersion in which it is dispersed in an appropriate solvent. The inorganic dispersion may be prepared using a general method without a particular limit, for example, using a method of adding an appropriate amount of surface-treated Al₂O₃ to an appropriate solvent and then, dispersing the mixture by milling the same with a beads mill.

The composition for forming the porous heat-resistant layer may include a polymerization initiator for crosslinking materials producing the crosslinked structure binder and/between the crosslinked structure binder and the surface-treated inorganic particle. The polymerization initiator may work as a hardener generating a glass radical by heat or light and be appropriately selected depending on a kind of the materials producing the crosslinked structure binder and a kind of a functional group of the inorganic particle. For example, the polymerization initiator use a thermal polymerization initiator such as a peroxide-based, azo-based, amine-based, imidazole-based, or isocyanate-based, or a photopolymerization initiator such as an onium salt, or an organic metal salt. Examples of the peroxide-based initiator may be Examples of the peroxide-based initiator may be t-butyl peroxylaurate, 1,1,3,3-t-methylbutylperoxy-2-ethyl hexanonate, 2,5-dimethyl-2,5-di(2-ethylhexanoyl peroxy) hexane, 1-cyclohexyl-1-methylethyl peroxy-2-ethyl hexanonate, 2,5-dimethyl-2,5-di(m-toluoyl peroxy) hexane, t-butyl peroxy isopropyl monocarbonate, t-butyl peroxy-2-ethylhexyl monocarbonate, t-hexyl peroxy benzoate, t-butyl peroxy acetate, dicumyl peroxide, 2,5,-dimethyl-2,5-di(t-butyl peroxy) hexane, t-butyl cumyl peroxide, t-hexyl peroxy neodecanoate, t-hexyl peroxy-2-ethyl hexanonate, t-butyl peroxy-2-2-ethylhexanonate, t-butyl peroxy isobutyrate, 1,1-bis(t-butyl peroxy)cyclohexane, t-hexyl peroxy isopropyl monocarbonate, t-butyl peroxy-3,5,5-trimethyl hexanonate, t-butyl peroxy pivalate, cumyl peroxy neodecanoate, di-isopropyl benzene hydroperoxide, cumene hydroperoxide, isobutyl peroxide, 2,4-dichloro benzoyl peroxide, 3,5,5-trimethyl hexanoyl peroxide, octaniyl peroxide, lauryl peroxide, stearoyl peroxide, succin peroxide, benzoyl peroxide, 3,5,5-trimethyl hexanoyl peroxide, benzoyl peroxy toluene, 1,1,3,3-tetramethyl butyl peroxy neodecanoate, 1-cyclohexyl-1-methyl ethyl peroxy nodecanoate, di-n-propyl peroxy dicarbonate, di-isopropyl peroxy carbonate, bis(4-t-butyl cyclohexyl) peroxy dicarbonate, di-2-ethoxy methoxy peroxy dicarbonate, di(2-ethyl hexyl peroxy) dicarbonate, dimethoxy butyl peroxy dicarbonate, di(3-methyl-3-methoxy butyl peroxy) dicarbonate, 1,1-bis(t-hexyl peroxy)-3,3,5-trimethyl cyclohexane, 1,1-bis(t-hexyl peroxy) cyclohexane, 1,1-bis(t-butyl peroxy)-3,3,5-trimethyl cyclohexane, 1,1-(t-butyl peroxy) cyclododecane, 2,2-bis(t-butyl peroxy)decane, t-butyl trimethyl silyl peroxide, bis(t-butyl) dimethyl silyl peroxide, t-butyl triallyl silyl peroxide, bis(t-butyl) diallyl silyl peroxide, tris(t-butyl) aryl silyl peroxide, and the like. Examples of the azo-based initiator may include 2,2′-azobis(4-methoxy-2,4-dimethyl valeronitrile), dimethyl 2,2′-azobis(2-methyl propionate), 2,2′-azobis(N-cyclohexyl-2-methyl propionate), 2,2-azobis(2,4-dimethyl valeronitrile), 2,2′-azobis(2-methyl butyronitrile), 2,2′-azobis[N-(2-propenyl)-2-methylpropionate], 2,2′-azobis(N-butyl-2-methyl propionate), 2,2′-azobis[N-(2-propenyl)-2-methyl propionate], 1,1′-azobis(cyclohexane-1-carbonitrile), 1-[(cyano-1-methylethyl)azo] formamide, and the like. Examples of the isocyanate-based initiator may include a polyisocyanate-based initiator, and may be aliphatic polyisocyanate, alicyclic polyisocyanate, directionaliphatic polyisocyanate, aromatic polyisocyanate, a derivative thereof or a modified product thereof, and the like. For example, trimethylenediisocyanate, tetramethylene diisocyanate, hexamethylenediisocyanate, pentamethylenediisocyanate, 1,2-propylenediisocyanate, 1,2-butylenediisocyanate, 2,3-butylenediisocyanate, 1,3-butylenediisocyanate, 2,4,4- or 2,2,4-trimethylhexamethylenediisocyanate, 2,6-diisocyanatemethylcaproate, lysine ester triisocyate, 1,4,8-triisocyanateoctane, 1,6,11-triisocyanateundecane, 1,8-diisocyanate-4-isocyanatemethyloctane, 1,3,6-triisocyanatehexane, 2,5,7-trimethyl-1,8-diisocyanate-5-isocyanatemethyloctane, and the like. Other thermal polymerization initiator may be for example benzophenone (BZP from Aldrich), 2,6-bis(azidobenzylidene)-4-methylcyclohexanone (bisazido from Aldrich), 2,2-dimethoxy-2-phenylacetophenone, 1-benzoyl-1-hydroxycyclohexane, 2,4,6-trimethylbenzoyl diphenyl phosphine oxide, a 3-methyl-2-butenyltetramethylene sulfonium hexafluoro antimonate salt, a ytterbium trifluoromethane sulfonate salt, a samarium trifluoromethane sulfonate salt, an erbium trifluoromethane sulfonate salt, a dysprosium trifluoromethane sulfonate salt, a lanthanum trifluoromethane sulfonate salt, a tetrabutyl phosphonium methane sulfonate salt, an ethyltriphenyl phosphonium bromide slat, benzyldimethylamine, dimethylaminomethyl phenol, triethanolamine, 2-methylimidazole, 2-ethyl-4-methylimidazole, 1,8-diaza-bicyclo(5,4,0)udecene-7, triethylenediamine, and tri-2,4-6-dimethylaminomethylphenol, and the like.

Examples of the photopolymerization initiator may be an aryl sulfonium hexafluoroantimonate salt, a diphenyldiiodonium hexafluorophosphate salt, diphenyl iodonium hexaantimonium salt, a ditolyliodonium hexafluorophosphate salt, a 9-(4-hydroxyethoxyphenyl)dianthrenium hexafluorophosphate salt, and the like.

The polymerization initiator may be included in an amount of 1 part by weight to 10 parts by weight, specifically 1 part by weight to 5 parts by weight based on 100 parts by weight of the crosslinkable binder.

In addition, the porous heat-resistant layer composition may include an appropriate solvent in order to disperse the monomer, oligomer, polymer or mixture thereof having one or more functional group; and the inorganic particle.

The solvent is not particularly limited, but may be a C1 to C15 alcohol, a hydrocarbon solvent such as aliphatic hydrocarbon, alicyclic hydrocarbon, aromatic hydrocarbon, and the like, a halogenated hydrocarbon solvent, an ether such as an aliphatic ether, an alicyclic ether, and the like, a mixture thereof, and the like. For example, it may be ketones such as acetone, methylethylketone, methylbutylketone, methylisobutylketone, cyclohexanone, and the like, ethers such as ethylether, dioxane, tetrahydrobutane, and the like, esters such as methyl acetate, ethyl acetate, propyl acetate, isopropyl acetate, butyl acetate, isobutyl acetate, pentyl acetate, isopentyl acetate, and the like, alcohols such as butanol, 2-butanol, isobutanol, isopropylalcohol, ethanol, methanol, and the like, halogenated hydrocarbons such as dichloromethane, chloroform, dichloroethane, trichloroethane, tetrachloroethane, dichloroethylene, trichloroethylene, tetrachloroethylene, chlorobenzene, and the like, or hydrocarbons such as n-hexane, cyclohexanol, methylcyclohexanol, benzene, toluene, and the like.

The solvent may be included in an amount of 20 wt % to 99 wt %, specifically 50 wt % to 95 wt %, and more specifically 70 wt % to 95 wt % based on a weight of the porous heat-resistant layer composition. Within the ranges, a composition may be easily prepared and a subsequent drying process may be smoothly performed.

In another example embodiment of the present invention, the porous heat-resistant layer may further include a non-crosslinkable binder. The present example embodiment includes substantially the same constituent elements as the aforementioned example embodiment except for the non-crosslinkable binder, and thus the non-crosslinkable binder is mainly illustrated.

The porous heat-resistant layer may further improve adherence to a substrate or an electrode and heat resistance by additionally including the non-crosslinkable binder. The additionally added non-crosslinkable binder may be polyvinylidene fluoride (PVdF)-based polymer. The polyvinylidene fluoride-based polymer may be a polyvinylidene fluoride homopolymer, a polyvinylidene fluoride copolymer, or a mixture thereof. The polyvinylidene fluoride homopolymer may refer to a polymer including a repeating unit derived from vinylidene fluoride (VDF) alone or 5 wt % or less of other repeating unit in addition to the repeating unit derived from vinylidene fluoride. Herein, the polyvinylidene fluoride homopolymer does not a repeating unit derived from hexafluoropropylene (HFP) as the other repeating unit. The polyvinylidene fluoride copolymer refers to polymerization of other monomer that is different from vinylidene fluoride, and may specifically include a repeating unit derived from hexafluoropropylene or a vinylidene fluoride repeating unit and greater than 5 wt % of other repeating unit except a repeating unit derived from hexafluoropropylene. The polyvinylidene fluoride copolymer may include a polyvinylidene fluoride-hexafluoropropylene (PVdF-HFP)-based copolymer including a repeating unit derived from vinylidene fluoride and a repeating unit derived from hexafluoropropylene. The polyvinylidene fluoride-hexafluoropropylene-based copolymer may include a polyvinylidene fluoride-hexafluoropropylene (PVdF-HFP) binary copolymer, or a ternary or more copolymer including other additional repeating unit in addition to a repeating unit derived from vinylidene fluoride and a repeating unit derived from hexafluoropropylene. For example, the non-crosslinkable binder may be a polyvinylidene fluoride homopolymer.

When the crosslinked structure binder is included with the non-crosslinkable binder, the crosslinked structure binder and the non-crosslinkable binder may be used in a weight ratio of 8:2 to 2:8 and specifically 3:7 to 7:3. Within the range, the most excellent adherence and heat resistance compensation effect may be obtained.

In addition, according to another embodiment of the present invention, the porous heat-resistant layer may additionally include a non-surface-treated inorganic particle in addition to the surface-treated inorganic particle. The present embodiment is different from the former embodiments, in that the non-surface-treated inorganic particle is additionally included, even thought the other constitutions are substantially equivalent, and thus the non-surface-treated inorganic particle will be mainly illustrated. In the present specification, the ‘non-surface-treated inorganic particle’ is not surface-treated with a functional group and the like reactable with the aforementioned crosslinkable binder and thus may not react with the crosslinkable binder. For example, the ‘non-surface-treated inorganic particle’ may be an inorganic particle surface-treated with other coupling agents and the like which do not react with the crosslinkable binder.

The non-surface-treated inorganic particle may be an inorganic particle generally used in the related art. Specific examples of the non-surface-treated inorganic particle may be Al₂O₃, ZnO₂, SiO₂, B₂O₃, Ga₂O₃, TiO₂, SnO₂, or the like, which may be used alone or as a mixture of two or more. Specifically, Al₂O₃ (alumina) may be used.

The non-surface-treated inorganic particle may have no particular limit regarding a size but an average particle diameter ranging from 1 nm to 1,000 nm, specifically, 100 nm to 1,000 nm, and more specifically 200 nm to 800 nm.

When the porous heat-resistant layer includes the surface-treated inorganic particle and the non-surface-treated inorganic particle, the surface-treated inorganic particle and the non-surface-treated inorganic particle may be used in a weight ratio ranging from 5:95 to 20:80. When the porous heat-resistant layer includes the surface-treated inorganic particle and the non-surface-treated inorganic particle together, an total amount of the inorganic particle may be greater than or equal to 50 wt %, specifically 50 wt % to 95 wt %, specifically 60 wt % to 95 wt %, and more specifically 75 wt % to 95 wt % based on the total solid of the porous heat-resistant layer. When the inorganic particle is included within the range, sufficient heat-resistant properties of the inorganic particle may be obtained, and when a separation membrane is coated therewith, the separation membrane may be effectively suppressed from a thermal shrinkage.

Hereinafter, a method of manufacturing a separation membrane according to example embodiments of the present invention is described.

The porous heat-resistant layer composition may be prepared by mixing the crosslinkable binder, the inorganic particle surface-treated with the functional group, a polymerization initiator, and a solvent and stirring the same.

According to another embodiment of the present invention, when the non-surface-treated inorganic particle is further included, it may be mixed with the surface-treated inorganic particle.

In addition, when the composition includes a non-crosslinkable binder according to another embodiment of the present invention, the non-crosslinkable binder may be dispersed in an appropriate solvent in advance.

The mixing may be performed by using a ball mill, a bead mill, a screw mixer, or the like.

Subsequently, a porous heat-resistant layer is formed from the porous heat-resistant layer composition on one surface or both surfaces of a porous substrate. Before forming the heat-resistant layer on one surface or both surfaces of the porous substrate, the porous substrate may be optionally pre-treated, for example, sulfonated, graft-treated, corona-discharged, radiated by ultraviolet rays, plasma-treated, spatter-etched, or the like to improve close contacting property with the porous heat-resistant layer. Through the pre-treatment, the porous heat-resistant layer may have, for example, an island shape or a thin film shape.

A method of forming the porous heat-resistant layer on the porous substrate by using the composition for a porous heat-resistant layer has no particular limit but may include any method commonly used in a related art of the present invention, for example, coating, lamination, coextrusion, and the like. Non-limiting examples of the coating may be a roll coating, a spin coating, a dip coating, a flow coating, a spray coating, and the like, but are not limited thereto. The heat-resistant layer of the separation membrane of the present invention may be for example formed by dip coating or spin coating.

Subsequently, the porous heat-resistant layer may be photocured or thermally cured. The photocuring may be specifically performed by using ultraviolet rays or far-infrared rays, for example, ultraviolet rays. The photocuring may include for example, radiation of a light dose of 500 mJ/cm² to 3000 mJ/cm² and specifically, 500 mJ/cm² to 2000 mJ/cm² into the porous heat-resistant layer. The radiation may be performed for 1 minute to 15 hours. After the photocuring, a subsequent heat treatment may be performed at greater than or equal to about 50° C. and less than or equal to about 180° C. for 1 hour to 10 hours to obtain homogeneous curing density. In addition, the thermal curing may be performed at about 40° C. to 120° C., specifically 50° C. to 100° C. for 1 hour to 36 hours and specifically for about 5 hours to 24 hours.

A thickness of the porous heat-resistant layer may be 1 μm to 15 μm, specifically 1 μm to 10 μm, and more specifically 1 μm to 5 μm. When the porous heat-resistant layer having the thickness within the ranges is formed, excellent thermal stability and adherence may be obtained and an entire thickness of the separation membrane is prevented from being extremely thick to suppress an internal resistance increase of a battery.

The separation membrane according to an example embodiment of the present invention may have air permeability of less than or equal to 300 sec/100 cc. Specifically, the air permeability may be less than or equal to 250 sec/100 cc, and more specifically 200 sec/100 cc.

A method of measuring the air permeability of the separation membrane is not particularly limited. The air permeability may be measured in a method generally used in a related art of the present invention, and non-limiting examples of the method are as follows: the separation membrane is cut into a size of 5 cm×5 cm from its left, middle, and right regions to prepare three specimens, and air permeability of the specimens is obtained by respectively three times measuring how long it takes for air of 100 cc to pass each specimen with an air permeability measuring device EG01-55-1MR (Asahi Seiko Inc., Japan) and averaging the measurements.

In addition, the separation membrane may have each thermal shrinkage rate of less than or equal to 50% in an MD direction and a TD direction after allowed to stand at 200° C. for 10 minutes. Specifically, the thermal shrinkage rate may be less than or equal to 46% and specifically, less than or equal to 41%.

A method of measuring the thermal shrinkage rate of the separation membrane is not particularly limited. The method of measuring the shrinkage rate may be a method generally used in a related art of the present invention, and non-limiting examples of the method are as follows: ten specimens are parepared by cutting the separation membrane into a size of a width (MD) 5 cm×a length (TD) 5 cm from ten different places and then, allowed to stand at 200° C. in an oven for 10 minutes, and a shrinkage of the specimens in horizontal and vertical directions are measured at 200° C.

A separation membrane having the thermal shrinkage rate and the air permeability has excellent heat resistance as well as easily passes ions between negative and positive electrodes and thus effectively prevents a short circuit of the electrodes and improve safety of a battery.

In addition, when the separation membrane is cut into a size of 5 cm×5 cm in MD and TD directions, fixed with a polyimide tape at four sides on a plate, and allowed to stand at 250° C. for 10 minutes, the separation membrane may not be rupture. The method of measuring rupture heat resistance may be one example but is not limited thereto. The rupture heat resistance is a parameter showing that the fixed separation membrane is not shrunk but rupture at a high temperature and measured by cutting the separation membrane into a sized of 5 cm×5 cm in MD and TD directions, fixing four sides of each cut separation membrane on a plate with a polyimide tape, allowing the plate to stand at 250° C. in an oven for 10 minutes, and examining whether or not the separation membrane is rupture with naked eyes. Since a separation membrane is fixed between positive and negative electrodes in a battery, the rupture heat resistance may be used as an index for heat resistance of the fixed separation membrane unlike a conventional index for heat resistance such as a thermal shrinkage rate and the like.

The separation membrane may have adherence to a porous substrate (hereinafter, substrate adherence) of greater than or equal to 0.1 N/mm, specifically, greater than or equal to 0.11 N/mm, and specifically greater than or equal to 0.12 N/mm. When the substrate adherence is within the range, the heat resistant layer has excellent adherence to the porous substrate and thus may maintain long term battery performance. The substrate adherence may be measured in a method generally used in a related art of the present invention (ASTM-D903) without a particular limit. Non-limiting examples of the method of measuring the substrate adherence of the separation membrane are as follows: the separation membrane is cut into a size of 1.2 cm (MD direction)×5 cm (TD direction), and the cut separation membrane is fixed with a tape (Scotch, 3M) except for both ends. Subsequently, one end of the cut separation membrane is clipped with an upper action grip of an UTM (Mode3343, Instron Corp.) equipment, while the tape at the other end is clipped with a lower action grip to measure delamination power of the porous heat-resistant layer from the porous substrate and thus obtain the substrate adherence.

Another example embodiment of the present invention provides a lithium secondary battery including a positive electrode, a negative electrode, the separation membrane disclosed in the present application and disposed between the positive electrode and the negative electrode, and an electrolyte solution.

The lithium secondary battery is not particularly limited, and may be any known in this art of the present invention. Specifically, the lithium secondary battery of the present invention may be a lithium metal secondary battery, lithium ion secondary battery, a lithium polymer secondary battery, or a lithium ion polymer secondary battery.

A method of manufacturing the lithium secondary battery of the present invention is not particularly limited, and a general method in this art of the present invention may be used.

Specifically, a non-limiting example of the method of manufacturing a lithium secondary battery according to an embodiment of the present invention is as follows: a separation membrane including the heat-resistant layer of the present invention is disposed between a positive electrode and a negative electrode of a battery and an electrolyte solution is filled therein.

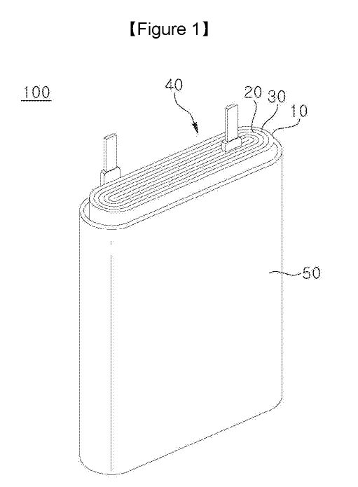

FIGS. 1 and 2 are exploded perspective view of a lithium secondary battery according to an embodiment. A lithium secondary battery according to an embodiment is for example illustrated with a prismatic battery, but the present invention is not limited thereto, and the separation membrane may be applied to various batteries such as a lithium polymer battery, a cylindrical battery, and the like.

Referring to FIG. 1, a lithium secondary battery 100 according to an embodiment includes a wound electrode assembly 40 including a separation membrane 30 between a positive electrode 10 and a negative electrode 20, and case 50 housing the electrode assembly 40. The positive electrode 10, the negative electrode 20, and the separation membrane 30 are impregnated in an electrolyte solution (not shown).

The separation membrane 30 is the same as described above.

The positive electrode 10 includes a positive current collector and a positive active material layer formed on the positive current collector. The positive active material layer may include a positive active material, a binder, and optionally a conductive material.

The positive current collector may use aluminum (Al), nickel (Ni), and the like, but is not limited thereto.

The positive active material may use a compound being capable of intercalating and deintercalating lithium. Specifically at least one of a composite oxide or a composite phosphate of a metal selected from cobalt, manganese, nickel, aluminum, iron, or a combination thereof and lithium may be used. More specifically, the positive active material may use a lithium cobalt oxide, a lithium nickel oxide, a lithium manganese oxide, a lithium nickel cobalt manganese oxide, a lithium nickel cobalt aluminum oxide, a lithium iron phosphate, or a combination thereof.

The binder improves binding properties of positive active material particles with one another and with a current collector and specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. These may be used alone or as a mixture of two or more.

The conductive material improves conductivity of an electrode and examples thereof may be natural graphite, artificial graphite, carbon black, a carbon fiber, a metal powder, a metal fiber, and the like, but are not limited thereto. These may be used alone or as a mixture of two or more. The metal powder and the metal fiber may use a metal of copper, nickel, aluminum, silver, and the like.

The negative electrode 20 includes a negative current collector and a negative active material layer formed on the negative current collector.

The negative current collector may use copper (Cu), gold (Au), nickel (Ni), a copper alloy, and the like, but is not limited thereto.

The negative active material layer may include a negative active material, a binder and optionally a conductive material.

The negative active material may be a material that reversibly intercalates/deintercalates lithium ions, a lithium metal, a lithium metal alloy, a material capable of doping and dedoping lithium, a transition metal oxide, or a combination thereof.

The material that reversibly intercalates/deintercalates lithium ions may be a carbon material which is any generally-used carbon-based negative active material, and examples thereof may be crystalline carbon, amorphous carbon, or a combination thereof. Examples of the crystalline carbon may be graphite such as amorphous, sheet-shape, flake, spherical shape or fiber-shaped natural graphite or artificial graphite. Examples of the amorphous carbon may be soft carbon or hard carbon, a mesophase pitch carbonized product, fired coke, and the like. The lithium metal alloy may be an alloy of lithium and a metal selected from the group consisting of Na, K, Rb, Cs, Fr, Be, Mg, Ca, Sr, Si, Sb, Pb, In, Zn, Ba, Ra, Ge, Al, and Sn. The material being capable of doping and dedoping lithium may be Si, SiOₓ (0<x<2), a Si—C composite, a Si—Y alloy, Sn, SnO₂, a Sn—C composite, a Sn—Y alloy, and the like, and at least one of these may be mixed with SiO₂. The element Y may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof. The transition metal oxide may be vanadium oxide, lithium vanadium oxide, and the like.

The binder and the conductive material used in the negative electrode may be the same as the binder and conductive material of the positive electrode.

The positive electrode and the negative electrode may be manufactured by mixing each active material composition including each active material and a binder, and optionally a conductive material in a solvent, and coating the active material composition on each current collector. Herein, the solvent may be N-methylpyrrolidone, and the like, but is not limited thereto. The electrode manufacturing method is well known, and thus is not described in detail in the present specification.

The electrolyte solution includes an organic solvent and a lithium salt.

The organic solvent serves as a medium for transmitting ions taking part in the electrochemical reaction of a battery. Specific examples thereof may be selected from a carbonate-based solvent, an ester-based solvent, an ether-based solvent, a ketone-based solvent, an alcohol-based solvent, and an aprotic solvent.

Examples of the carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. Particularly, when the linear carbonate compounds and cyclic carbonate compounds are mixed, an organic solvent having a high dielectric constant and a low viscosity may be provided. The cyclic carbonate compound and the linear carbonate compound are mixed together in a volume ratio ranging from 1:1 to 1:9.

Examples of the ester-based solvent may be methylacetate, ethylacetate, n-propylacetate, dimethylacetate, methylpropionate, ethylpropionate, γ-butyrolactone, decanolide, valerolactone, mevalonolactone, caprolactone, and the like. Examples of the ether-based solvent may be dibutylether, tetraglyme, diglyme, dimethoxyethane, 2-methyltetrahydrofuran, tetrahydrofuran, and the like. Examples of the ketone-based solvent may be cyclohexanone, and the like, and examples of the alcohol-based solvent may be ethanol, isopropyl alcohol, and the like.

The organic solvent may be used alone or in a mixture of two or more, and when the organic solvent is used in a mixture of two or more, the mixture ratio may be controlled in accordance with a desirable cell performance.

The lithium salt is dissolved in an organic solvent, supplies lithium ions in a battery, basically operates the secondary battery, and improves lithium ion transportation between positive and negative electrodes therein.

Examples of the lithium salt may be LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂), wherein x and y are natural numbers, LiCl, LiI, LiB(C₂O₄)₂, or a combination thereof.

The lithium salt may be used in a concentration ranging from 0.1 M to 2.0 M. When the lithium salt is included within the above concentration range, an electrolyte may have excellent performance and lithium ion mobility due to optimal electrolyte conductivity and viscosity.

An electrochemical battery according to another embodiment of the present invention a 100 cycle charge and discharge maintenance rate of 70% to 100% and specifically, 80% to 100%.

Hereinafter, Examples, Comparative Examples, and Experimental Examples are illustrated to explain the present invention in more detail. However, the following Preparation Examples, Examples, Comparative Examples, and Experimental Examples are exemplary, and the present invention is not limited thereto.

Furthermore, what is not described in this invention may be sufficiently understood by those who have knowledge in this field and will not be illustrated here.

### EXAMPLES AND COMPARATIVE EXAMPLES

### Preparation Examples 1 to 6: Preparation of Porous Heat-Resistant Layer Composition

### Preparation Example 1

1st Step: Preparation of Surface-Treated Alumina

A surface-treated alumina in 30% solid slurry was prepared by dispersing alumina having a size of 15 nm and surface-treated with methacryl silane (Optisol-LAK230U, Ranco Co., Korea) in MEK (methylethylketone).

2nd Step: Preparation of Porous Heat-Resistant Layer Composition

After putting acetone in an agitation tank, 10 wt % of the surface-treated alumina obtained in the 1st step and 80 wt % of non-surface-treated alumina (a size of 500 nm, LS235, Nippon Light Metal Company, Ltd., Japan) based on the total weight of a solid in a prepared composition were added thereto, and the mixture was stirred with a mechanical stirrer for 30 minutes.

10 wt % of multi-functional urethane acrylate (EPS587, DIC Co., Ltd., Japan) was put in the agitation tank, 5 parts by weight of benzoyl peroxide (BPO, Daejung Chemicals & Metals Co., Ltd.) as an initiator was added thereto based on a solid of the multi-functional urethane acrylate, and the obtained mixture was additionally stirred for 30 minutes to prepare a composition according to Preparation Example 1.

With a reference to the total solid of the composition, the surface-treated alumina was included in an amount of 10 wt %, and the multi-functional urethane acrylate was included in an amount of 10 wt %.

### Preparation Example 2

A composition according to Preparation Example 2 was prepared according to the same method as Preparation Example 1 except for using 10 wt % of ethoxylated pentaerythritol tetraacrylate (PE-044, Hannong Chemicals Inc.) instead of the multi-functional urethane acrylate

### Preparation Example 3

A composition according to Preparation Example 3 was prepared according to the same method as Preparation Example 2 except for using 90 wt % of the surface-treated alumina based on the total solid of the composition but not using the non-surface-treated alumina.

### Preparation Example 4

A composition according to Preparation Example 4 was prepared according to the same method as Preparation Example 1 except for further including 5 wt % of a transparent PVdF-based solution obtained by mixing a polyvinylidene fluoride (PVdF)-based binder (KF9300, Kureha Chemical Industries, Japan):acetone:DMAc in a weight ratio of 7:36:57 and stirring the mixture for 30 minutes based on the total solid of the composition in addition to the multi-functional urethane acrylate.

The surface-treated alumina was used in an amount of 10 wt %, the non-surface-treated alumina in an amount of 75 wt %, the multi-functional urethane acrylate in an amount of 10 wt %, and the polyvinylidene fluoride in an amount of 5 wt % based on the total solid of the composition.

### Preparation Example 5

A composition according to Preparation Example 5 was prepared according to the same method as Preparation Example 1 except for using not the surface-treated alumina but 90 wt % of the non-surface-treated alumina.

### Preparation Example 6

A composition according to Preparation Example 6 was prepared by dissolving 10 wt % of polyvinylidene fluoride in a mixed solution of acetone/DMAc (=4:6 of a weight ratio) and 90 wt % of the non-surface-treated alumina (a size of 500 nm, LS235, Nippon Light Metal Company, Ltd., Japan) and stirring the mixture for 2 hours.

The non-surface-treated alumina was used in an amount of 90 wt %, and the polyvinylidene fluoride was used in an amount of 10 wt % based on the total solid of the composition.

### Manufacture of Separation Membrane

The compositions according to Preparation Examples 1 to 6 were respectively coated to be 2 μm thick on one surface of a 12 μm-thick polyethylene fabric panel (made by SKI). Subsequently, the coated compositions were thermally cured at 85° C. for 24 hours to respectively obtain eacg 14 μm-thick separation membrane according to Examples 1 to 4 and Comparative Examples 1 and 2.

Components used in the compositions and heat resistant layers according to Examples 1 to 4 and Comparative Examples 1 and 2 and their contents are provided in Table 1.

TABLE 1

| | | | | | Comparative | Comparative |
|---|---|---|---|---|---|---|
| | Example | Example | Example | Example | Example | Example |
| | 1 | 2 | 3 | 4 | 1 | 2 |
| | Preparation | Preparation | Preparation | Preparation | Preparation | Preparation |
| | Example | Example | Example | Example | Example | Example |
| Components | 1 | 2 | 3 | 4 | 5 | 6 |
| Multi-functional | 10 | — | — | 10 | 10 | — |
| urethane acrylate | | | | | | |
| Ethoxylated | — | 10 | 10 | — | — | — |
| pentaerythritol | | | | | | |
| tetraacrylate | | | | | | |
| PVdF-based binder | — | — | — | 5 | — | 10 |
| Surface-treated | 10 | 10 | 90 | 10 | — | — |
| alumina | | | | | | |
| Non-surface-treated | 80 | 80 | — | 75 | 90 | 90 |
| alumina | | | | | | |

### Experimental Example 1: Measurement of Thermal Shrinkage Rate

The separation membranes according to Examples and Comparative Examples were respectively cut into ten specimens having a width (MD) of 5 cm×a length (TD) of 5 cm from ten different places. After marking every 25 mm along the width and the length of each specimen and then, respectively allowing the marked specimens to stand at 200° C. in an oven for 10 minutes, shrinkages of each specimen in the horizontal and vertical directions were respectively measured and averaged to obtain an average thermal shrinkage rate at 200° C.

### Experimental Example 2: Rupture Heat Resistance

The separation membranes according to Examples and Comparative Examples were respectively cut into a size of a width of 5 cm and a length of 5 cm.

After making a 4 cm×4 cm square-shaped hole in the center of a 80 mm×80 mm metal jig, the cut separation membrane was put on the center of the metal jig. The separation membrane was fixed with a polyimide tape at four sides and positioned in an oven (LO-FS050, LKLABKOREA Inc., Korea) at 200° C., 230° C., and 250° C. for 10 minutes and then, examined regarding whether or not it was ruptured, and herein, when ruptured, Fail was given, while when not ruptured, Pass was given.

### Experimental Example 3: Adherence to Substrate

A test was performed according to Article 8 of the Korean Industrial Standard KS-A-01107 (an adhesive tape and an adhesive sheet test method). The separation membranes were respectively cut into a size of 1.2 cm (MD direction)×5 cm (TD direction) and adhered to a tape (Scotch, 3M) except for 5 mm or so of both ends of the cut separation membranes. Subsequently, one end out of both ends of each separation membrane not adhered with the tape was clipped with an upper action grip of an UTM (Mode3343, Instron Corp.) equipment, while the other end was clipped with a lower action grip to measure delamination power of a porous heat-resistant layer from a porous substrate and thus obtain substrate adherence.

The results of Experimental Examples 1 to 3 are shown in Table 2.

TABLE 2

| | | | | | | Comparative | Comparative |
|---|---|---|---|---|---|---|---|
| | | Example | Example | Example | Example | Example | Example |
| | | 1 | 2 | 3 | 4 | 1 | 2 |
| Thermal shrinkage | 200° C., 10 min | 41/39 | 41/39 | 33/32 | 37/35 | 46/40 | 57/55 |
| rate (MD/TD, %) | | | | | | | |
| Rupture heat | 200° C., 10 min | Pass | Pass | Pass | Pass | NG | NG |
| resistance | 230° C., 10 min | Pass | NG | NG | Pass | NG | NG |
| | 250° C., 10 min | Pass | NG | NG | Pass | NG | NG |

| | | | | | | |
|---|---|---|---|---|---|---|
| Adherence to substrate (N/mm) | 0.11 | 0.10 | 0.10 | 0.13 | 0.07 | 0.065 |

As shown in Table 2, Examples 1 to 4 including a crosslinked structure binder and the surface-treated inorganic particle showed excellent thermal shrinkage rate, rupture heat resistance, and adherence to a substrate compared with those of Comparative Examples 1 and 2.

On the other hand, Comparative Example 1 including a crosslinked structure binder but only the non-surface-treated inorganic particle showed a satisfactory thermal shrinkage rate but deteriorated rupture heat resistance and adherence to a substrate compared with those of Examples, but Comparative Example 2 including only a non-crosslinkable binder and the non-surface-treated inorganic particle showed all deteriorated properties compared with those of Examples.

1. A porous heat-resistant layer composition of a separation membrane for a battery, comprising:
a crosslinkable binder selected from a monomer, an oligomer, a polymer, or a mixture thereof having at least one functional group; an inorganic particle surface-treated with a functional group capable of reacting with the crosslinkable binder; a polymerization initiator; and a solvent.

2. The porous heat-resistant layer composition of a separation membrane for a battery of claim 1, wherein the monomer, the oligomer, the polymer, or the mixture thereof having at least one functional group is a monomer, an oligomer, or a polymer having a functional group selected from the group consisting of an acrylate group, a vinyl group, a hydroxy group, an epoxy group, an oxane group, an oxetane group, an ester group, and an isocyanate group.

3. The porous heat-resistant layer composition of a separation membrane for a battery of claim 1, wherein the inorganic particle surface-treated with the functional group is surface-treated with a functional group selected from the group consisting of an acrylate group, a vinyl group, a hydroxy group, an epoxy group, an oxane group, an oxetane group, an ester group, and an isocyanate group.

4. The porous heat-resistant layer composition of a separation membrane for a battery of claim 1, wherein the composition further includes a non-surface-treated inorganic particle.

5. The porous heat-resistant layer composition of a separation membrane for a battery of claim 1, wherein the crosslinkable binder is included in an amount of 5 to 50 wt % based on a total solid content of the porous heat-resistant layer composition.

6. The porous heat-resistant layer composition of a separation membrane for a battery of claim 1, wherein the composition further includes a non-crosslinkable binder.

7. The porous heat-resistant layer composition of a separation membrane for a battery of claim 6, wherein the non-crosslinkable binder is one or a mixture thereof selected from the group consisting of a polyvinylidenefluoride (PVdF)-based polymer, polymethylmethacrylate, polyacrylonitrile, polyvinylpyrrolidone, polyvinylacetate, polyethyleneoxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, and an acrylonitrile-butadiene-styrene copolymer.

8. A separation membrane for a battery, comprising
a porous substrate; and
a porous heat-resistant layer formed on one or both surfaces of the substrate,
wherein the porous heat-resistant layer includes a crosslinked structure binder and an inorganic particle, and
the inorganic particle is surface-treated with a functional group to react with the crosslinked structure binder.

9. The separation membrane for a battery of claim 8, wherein the crosslinked structure binder is obtained by curing the monomer, the oligomer, the polymer or the mixture thereof having at least one functional group.

10. The separation membrane for a battery of claim 9, wherein the monomer, the oligomer, the polymer, or the mixture thereof having at least one functional group is a monomer, an oligomer, or a polymer having at least one functional group selected from the group consisting of an acrylate group, a vinyl group, a hydroxy group, an epoxy group, an oxane group, an oxetane group, an ester group, and an isocyanate group.

11. The separation membrane for a battery of claim 8, wherein the functional group that surface-treats the inorganic particle is selected from the group consisting of an acrylate group, a vinyl group, a hydroxy group, an epoxy group, an oxane group, an oxetane group, an ester group, and an isocyanate group.

12. The separation membrane for a battery of claim 8, wherein the porous heat-resistant layer further includes a non-surface-treated inorganic particle.

13. The separation membrane for a battery of claim 8, wherein the inorganic particle is included in an amount of 50 wt % to 95 wt % based on the porous heat-resistant layer.

14. The separation membrane for a battery of claim 8, wherein the porous heat-resistant layer further includes a non-crosslinkable binder.

15. The separation membrane for a battery of claim 14, wherein the non-crosslinkable binder is one or a mixture thereof selected from the group consisting of a polyvinylidenefluoride (PVdF)-based polymer, polymethylmethacrylate, polyacrylonitrile, polyvinylpyrrolidone, polyvinylacetate, polyethyleneoxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose, and an acrylonitrile-butadiene-styrene copolymer.

16. The separation membrane for a battery of claim 8, which has each thermal shrinkage rate of 50% in a horizontal direction and a vertical direction after allowed to stand at 200° C. for 10 minutes.

17. The separation membrane for a battery of claim 8, which is not ruptured after allowed to stand at 250° C. for 10 minutes.

18. A lithium secondary battery, comprising:
a positive electrode; a negative electrode; the separation membrane for a battery of claim 8 disposed between the positive electrode and the negative electrode; and an electrolyte solution.
